(19) United States
(12) Patent Application Publication
(10) Pub. No.: US 2008/0094462 A1
(43) Pub. Date: Apr. 24, 2008

(54) Portable Data Processing System Having Print Capabilities

(76) Inventors: Ying-Hui Huang, Taipei City (TW); Yung-Chuan Wu, Taoyuan County (TW)

Correspondence Address: BIRCH, STEWART, KOLASCH & BIRCH, LLP, 8110 GATEHOUSE ROAD, SUITE 100 EAST, FALLS CHURCH, VA, 22315, US

(21) Appl. No.: 11/793,356

(22) PCT Filed: Dec. 15, 2004
(86) PCT No.: PCT/CN04/01454

§ 371 Date: Jun. 14, 2007

(51) Int. Cl. B41J 29/13

(52) U.S. Cl. 347/108

(57) ABSTRACT

A portable data processing system having print capabilities includes a portable computer having a housing, a print unit attached to the housing, and an ink container connected to the printhead of the print unit. The print unit includes a full page width ink jet printhead, a paper path, intake and output rollers, control circuitry, and electrical power and standard data protocol data connections with the portable computer. The use of a stationary printhead and a reduced clock rate allows full functionality of the print unit without sacrificing needed portability.

### FIELD OF THE INVENTION

This invention relates to a portable data processing system. More specifically, a portable data processing system having a compact, light weight and portable print unit is disclosed.

### BACKGROUND OF THE INVENTION

Today's demands for increasing functionality, miniaturization, and portability are very apparent throughout the technological world. The advent of many kinds of portable computer products, for example, notebook computers, PDAs, cellular phones, digital cameras, and DVs has gone far toward meeting these goals. For example, notebook computers include a power supply, a cpu, data buses, a keyboard and a touch pad, track ball, or joystick to facilitate data input, and an LCD panel for viewing the inputted data. Higher-level notebook computers also commonly include a CD/DVD drive and various attachments allowing exchange of data over a wired or wireless network.

Although these characteristics accommodate most user needs, obviously there are times when digitized data is not enough and connection to a printer for producing a hard copy of a document becomes a necessity. Currently, connection to a printer generally involves connecting to a network, which in turn, is connected to the needed printer, or taking the portable computer product to a location having a printer and making the appropriate connections. While this solution is practical and inexpensive due to the sharing of resources, this same solution severely limits portability of the computer system having printing capabilities. Often a network connection is not available, or if available the printer that is connected to the network is so far away from the user that use of that printer is impractical under the current circumstances. Additionally, due to size, weight, power requirements, and other factors, known printers cannot reasonably be considered portable, especially when only one or a few pages need printed.

Commonly today, users prefer non-impact printers and may choose between a laser printer and an ink jet printer. Laser printers are generally fast, produce good results, and are expensive. Much of the size and expense of laser printers revolve around the necessity of creating static charges and heat to place and bond the dry ink (toner) onto the paper. On the other hand, ink jet printers utilize liquid ink that is sprayed in tiny droplets onto the paper via either thermal bubble or piezoelectric technologies. Generally ink jet printers utilize a stepper motor to move a small, movable printhead back and forth across the paper with each round trip of the printhead producing one or two lines of print on the paper. The stepper motor, moving print cartridge and associated belt, and stabilizing bar required to ensure precise movement control all serve to prevent miniaturization and therefore portability.

On additional type of ink jet printer that was developed for very high speed printing (300-400 ppm) is disclosed in U.S. Pat. No. 4,559,543 issued to Toganoh, et al. and incorporated herein by reference. The disclosure utilizes of a plurality of smaller printheads juxtaposed or serially connected on a circuit board so that the combination of all the printheads form a full-width printhead capable of printing an entire line at one time by eliminating the problems associated with a moving print cartridge. The disclosed very high speed system obviously requires large ink supplies, a very precise paper feeding system, and systems to dry the ink as well as prevent the printer from overheating, again, making the disclosed device unpractical for a mobile system.

As such, the size, weight, and power requirements of any of the known types of printers prevent them from being part of a complete portable data processing system.

### SUMMARY OF THE INVENTION

The claimed invention discloses a truly a portable data processing system having print capabilities overcoming size, weight, and power requirements of known print units.

A data processing system according to the claimed invention includes a portable computer having a housing, a display screen, a keyboard, a pointing device, and a print unit connected to the housing of the portable computer. The print unit includes an ink container, at least one full page width ink jet printhead, a paper path, intake and output rollers, a motor for conveying paper through the paper path, circuitry, and electrical power and standard protocol data connections with the portable computer. The printhead may be an integrally formed plurality of ink jet nozzles or utilize a plurality of juxtaposed or serially connected smaller printheads. According to signals received from the circuitry, the printhead receives ink from an ink container and utilizing either a thermal bubble or a piezoelectric technology, sprays ink onto a paper moving within the paper path in a pattern determined by the signals received from the portable computer, one full line at a time. The print unit may be formed within a portion of the housing of the portable computer, or it may be detachably, physically connected to the housing. A predetermined clock rate allows full functionality of the print unit without resulting in increased size or in overheating or ink drying problems. Additionally, paper trays and complicated paper feeding systems are not needed.

These and other objectives of the claimed invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a diagram of a data processing system according to the present invention.

FIG. 2 is a functional diagram of a print unit within the data processing system of FIG. 1.

FIG. 3 is a partial cross-sectional view of the data processing system of FIG. 1.

FIG. 4 is functional diagram of another data processing system according to the present invention.

FIG. 5 is a top view of the data processing system of FIG. 4.

FIG. 6 is a partial cross-sectional view of the data processing system of FIG. 4.

### DETAILED DESCRIPTION OF THE INVENTION

In the following description, a notebook computer is used as an example of portable computer, but for the skilled person in the art, it should be easy to understand how to apply the present invention to other kinds of portable computer products without departing from the spirit of the invention.

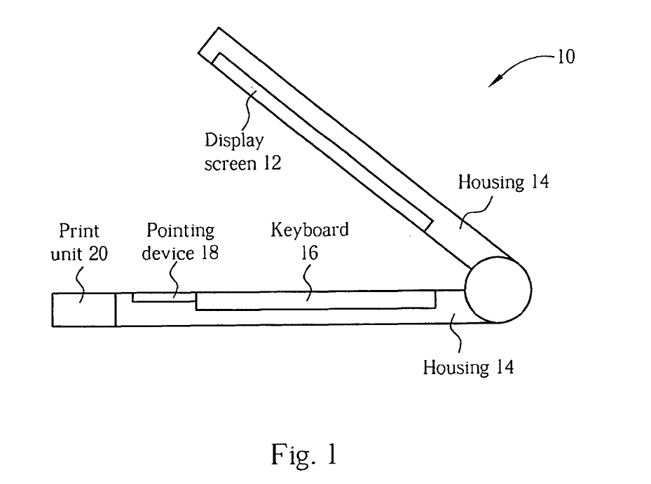

FIG. 1 is a side view diagram of a portable data processing system 10 according to the present invention. The data processing system 10 comprises a notebook computer having a housing 14, a display screen 12, a keyboard 16, a pointing device 18, and a print unit 20. The data processing system 10 may also comprise a battery or other power supply, CPU, memory, hard drive, and other components commonly found in a notebook computer. The display screen 12 preferably is an LCD. The pointing device may be a touch screen, track ball, joystick, or any other device capable of controlling cursor movement.

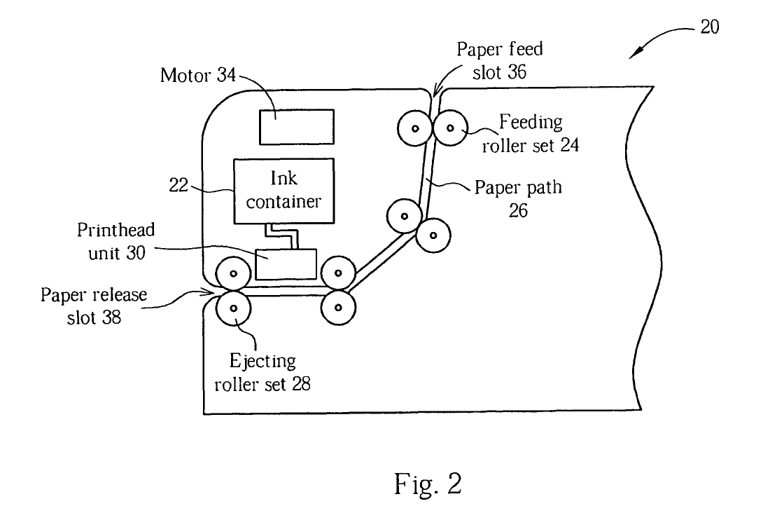

Please refer to FIG. 2, which is a cutaway side view of the print unit 20. The print unit 20 comprises an ink container 22 attached to a printhead 30. The ink container 22 may contain one or as many colors of ink as desired according to design considerations. Near the printhead 30 is a paper path 26 for allowing paper to move in front of the printhead 30 and receive predetermined ink. The paper path 26 is preferably but not necessarily curved to save room. Feeding roller set 24 and ejecting roller set 28 are spaced along the paper path 26 to provide and ensure proper conveyance of a paper within the paper path 26. A stepping motor 34 may be connected to one or more of the rollers 24, 28 for providing controlled movement of the paper. The print unit 20 additionally requires appropriate electrical and signal connections between comprised control circuitry, the motor 34, and the printhead unit 30 and the notebook computer of the data processing system 10. Signal can be passed to the print unit 20 from the notebook computer by any standard form of protocol such as USB, PCMCIA, IDE, IEEE 1284, or IEEE 1794 to name 5 non-limiting examples. Electrical power is preferably provided to the print unit 20 by the data processing system 10, however it may be possible to obtain power from an external source when needed. The print unit 20 may be formed within a portion of the housing 14, or it may be detachably physically connected to the housing 14 through a connecting device such as arms, clips, clamps, screws, or the like. Whether integrally formed or connected, the data processing system 10 in intended to be a portable, single unit.

The key to the present invention is the print unit 20. To retain the desired portability of the data processing system 10, the novel print unit 20 has been devised which minimizes size and weight while retaining full functionality. The present invention utilizes a full page width ink jet printhead 30 to avoid previously discussed size and weight restrictions caused by movable print cartridges. The printhead 30 may be an integrally formed of a plurality of ink jet nozzles so that a total simultaneously printable width (in the longest direction) of the printhead 30 is preferably about the width of a letter or A4 sized piece of paper. Another embodiment of the present invention utilizes a plurality of smaller ink jet units that each comprise a printhead having ink jet nozzles, with the ink jets units aligned next to each other on a circuit board or other surface so that in combination they form a printhead 30 of approximately the same width. According to signals received from the control circuitry, the printhead 30 receives ink from ink container 22 and utilizing either a thermal bubble or a piezoelectric technology, sprays ink onto a paper moving within the paper path 26 in a pattern determined by the print data received from the notebook computer of the data processing system 10, one full line at a time.

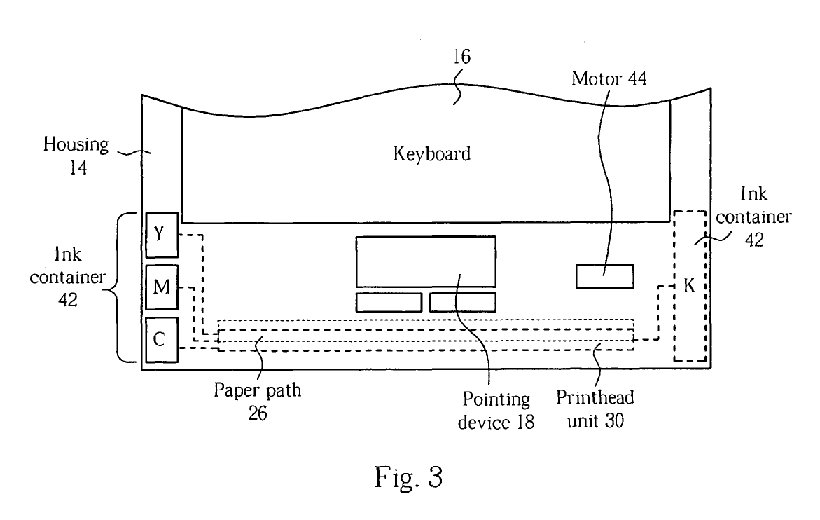

FIG. 3 illustrates an embodiment having a specialized arrangement of 4-color ink containers 42, although the present invention is not to be limited by this arrangement or number of ink containers. The embodiment shown in FIG. 3 includes the keyboard 16, housing 14, pointing device 18, and the printhead 30 of the former embodiments. Of particular note in this figure is a normal width relationship between the housing 14 and the printhead 30. As shown in FIG. 3, the housing 14 of most notebook computers is wider than the width required for the full page width ink jet printhead 30. Because areas at the ends of the printhead 30 are not needed for stopping a prior art movable print cartridge as the printhead 30 of the present invention remains substantially stationary, the areas at the two ends of the printhead 30 can be utilized to efficiently house the ink containers 42. FIG. 3 illustrates one such possible configuration comprising Yellow (Y), Magenta (M), Cyan (C), and Black (K) in ink containers 42 at the ends of, and connected to, the printhead 30, permitting the thickness of the data processing system 10 to be further reduced.

Because the data processing system 10 is designed to be as portable as possible, and because most notebook computers are battery operated, substantial space, cost, and power savings can be saved through modifications removing the necessity of components normally considered essential to a printing system. For example, the print unit 20 utilizes a relatively slow clock rate restricting the printing speed to a small number of documents per minute, perhaps less than 60, a relatively slow printing speed, providing several advantages. One direct advantage is that a slow clock rate effectively does away with heating problems and eliminates the prior art printing system's need for cooling and ink drying devices, at a substantial savings in power consumption, cost, and space. Additionally and with similar results, paper trays and complicated paper feeding systems are no longer needed. For example, when a user wishes to print a document, a single piece of paper may be inserted into the paper feed slot 36 where the feeding and ejecting rollers 24, 28 guide the inserted paper across the printhead 30 in a timely fashion.

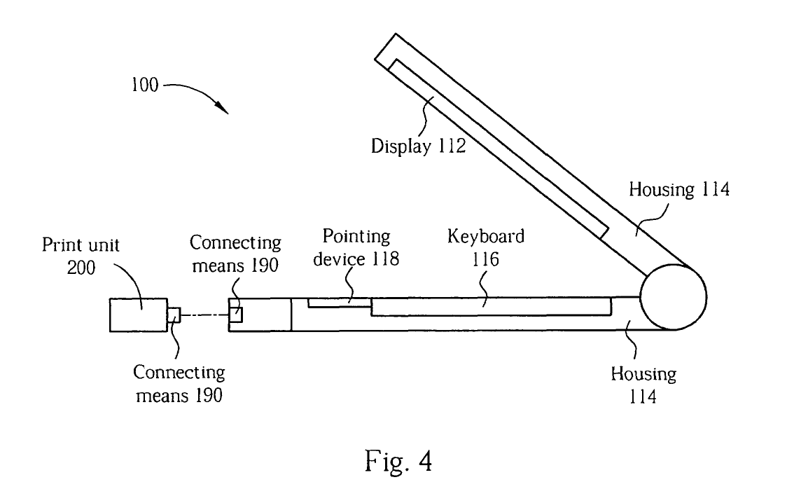

Please refer to FIG. 4, which is a side view diagram of another portable data processing system 100 according to the present invention. The data processing system 100 comprises a notebook computer having a housing 114, a display screen 112, a keyboard 116, a pointing device 118, and a print unit 200. The data processing system 100 may also comprise a battery or other power supply, CPU, memory, hard drive, and other components commonly found in a notebook computer. The display screen 112 preferably is an LCD. The pointing device 118 may be a touch screen, track ball, joystick, or any other device capable of controlling cursor movement.

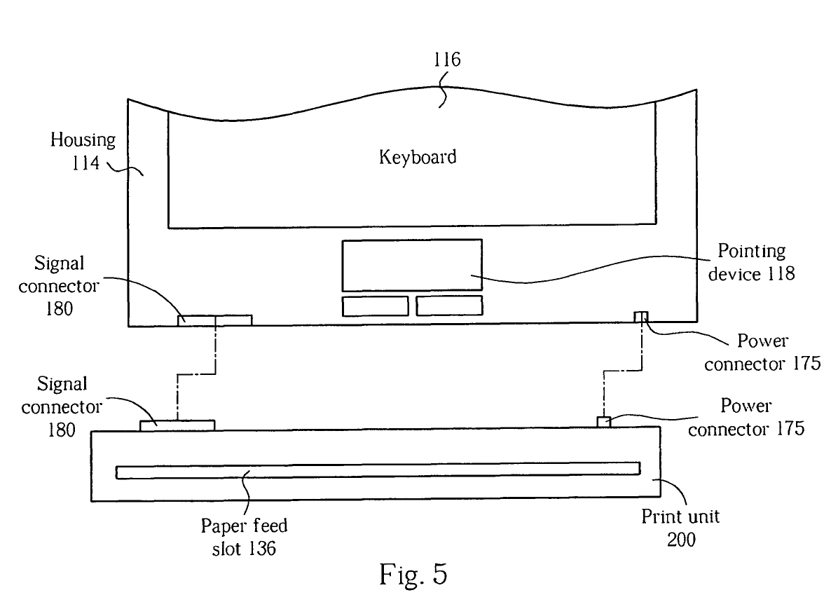

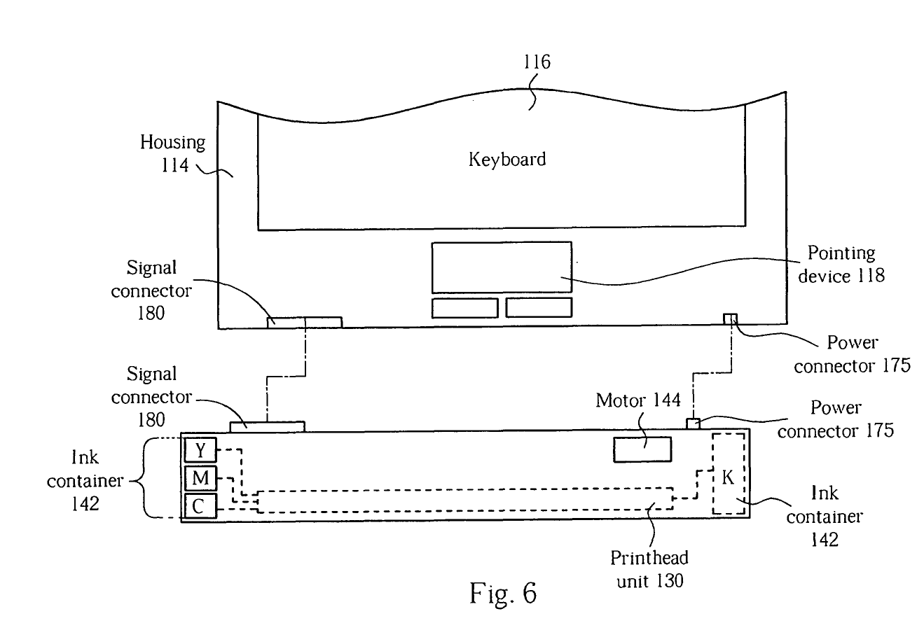

The print unit 200 comprises all of the same internal components and connections of the print unit 20 and is structurally and functionally similar to the print unit 20, so further elaboration on internal details seems unnecessary. One obvious difference between the print unit 200 and the print unit 20 is that the print unit 200 is capable of physically disconnected from the notebook computer. As illustrated in FIGS. 4-6, this detachability requires the portable data processing system 100 to comprise a connecting means 190 to allow physical and electrical connection of the print unit 200 to the housing 114 of notebook computer. The connecting means 190 may include a connecting device such as arms, clips, clamps, screws, or the like, as well as a signal connector 180 and a power connector 175. The signal connector 180 connects circuitry in the notebook computer with circuitry in the print unit 200 for obvious reasons as does the signal connector 180 and may utilize any standard form of protocol such as USB, PCMCIA, IDE, IEEE 1284, or IEEE 1794 to name 5 non-limiting examples. The power connector 175 may connect the print unit 200 with a power source within the housing 114 or optionally to an external source such as a conventional electrical wall socket. Several variations of the physical arrangements of the various components of the connecting means 190 would be readily apparent to one skilled in the art without exceeding the scope of the present invention.

Additionally illustrated is a printhead 130 that is structurally and functional akin to the printhead 30. An ink container 142 is connected to the printhead 130 preferrably in an arrangement similar to that of FIG. 3. Also shown are the motor 144 that drives feeding and/or ejecting rollers 24, 28 and the relative location of the paper feed slot 136.

In contrast to prior art, the present application discloses a novel portable data processing system that includes print capabilities. Previously, it was not practical to incorporate print capabilities into a portable data processing system due to size, weight, and power considerations. The present invention has eliminated those problems by creatively applying the use of a full page width ink jet printhead having a bare minimum of components with a notebook computer to form a truly a portable data processing system.

Those skilled in the art will readily observe that numerous modifications and alterations of the device may be made while retaining the teachings of the invention. Accordingly, the above disclosure should be construed as limited only by the metes and bounds of the appended claims.

1. A portable data processing system comprising:
a portable computer having a housing;
a print unit physically connected to the housing, the print unit comprising:
at least one full page width ink jet printhead; and
a paper conveying mechanism for conveying paper across the printhead; and
at least one ink container connected to the printhead;
wherein the portable computer operates the print unit according to signals transmitted from the portable computer to the print unit.

2. The portable data processing system of claim 1 wherein the conveying mechanism comprises at least a feeding roller connected to a motor within the print unit.

3. The portable data processing system of claim 1 further comprising a connection means for connecting the print unit to the portable computer.

4. The portable data processing system of claim 3 wherein the connection means electrically connects the print unit to a power supply of the portable computer for receiving electrical power from the portable computer.

5. The portable data processing system of claim 3 wherein the connection means comprises a signal connector that electrically connects circuitry within the print unit to circuitry within the portable computer.

6. The portable data processing system of claim 1 wherein the print unit is within the housing.

7. The portable data processing system of claim 6 wherein the print unit is detachably physically connected to the portable computer.

8. The portable data processing system of claim 1 wherein said at least one ink container is disposed adjacent to one end of the printhead or above the printhead.

9. The portable data processing system of claim 1 wherein the print unit utilizes a clock rate capable of printing approximately 1 to 60 pages per minute.

10. A portable data processing system comprising:
a portable computer having a housing;
a print unit detachably physically connected to the housing, the print unit comprising:
a means for physically connecting the print unit to the housing;
at least one full page width ink jet printhead within the print unit; and
a paper conveying mechanism for conveying paper across the printhead; and
at least one ink container connected to the printhead.

11. The portable data processing system of claim 10 wherein said at least one ink container is disposed adjacent to one end of the printhead or above the printhead.

12. The portable data processing system of claim 10 wherein the printhead utilizes a clock rate capable of printing less than 60 pages per minute.

13. A portable print unit comprising:
at least one full page width ink jet printhead;
at least one ink container connected to the printhead; and
a paper conveying mechanism for conveying paper across the printhead.

14. The portable print unit of claim 13 further comprising a power supply unit connected to the printhead unit for supplying electrical power to the print unit.

15. The portable print unit of claim 13 wherein said at least one ink container is disposed adjacent to one end of the printhead or above the printhead.

16. The portable print unit of claim 13 wherein the print unit utilizes a clock rate capable of printing approximately 1 to 60 pages per minute.

17. The portable print unit of claim 13 wherein the conveying mechanism comprises at least a feeding roller connected to a motor within the print unit.

18. The portable print unit of claim 13 further comprising a signal connection means for transferring signal to/from an external computer system.

19. The portable print unit of claim 18 wherein the signal connection means utilizes a wireless network protocol.
